(19) United States
(12) Patent Application Publication
(10) Pub. No.: US 2022/0095105 A1
(43) Pub. Date: Mar. 24, 2022

(54) MOBILE BODY COMMUNICATION SYSTEM

(71) Applicant: Mitsubishi Electric Corporation, Tokyo (JP)

(72) Inventors: Takashi MAEDA, Tokyo (JP); Takayoshi TAKEHARA, Tokyo (JP)

(73) Assignee: Mitsubishi Electric Corporation, Tokyo (JP)

(21) Appl. No.: 17/420,288

(22) PCT Filed: Feb. 22, 2019
(86) PCT No.: PCT/JP2019/006740

§ 371 Date: Jul. 1, 2021

(51) Int. Cl. H04W 12/06; H04W 8/24; H04W 8/00; H04W 76/14; H04W 88/18

(52) U.S. Cl. CPC H04W 12/06; H04W 8/24; H04W 88/18; H04W 76/14; H04W 8/005

(57) ABSTRACT

A mobile communication system performs, in a first communication device configured to provide a service in response to a request from a mobile body (30), authentication based on identification information on the mobile body (30), and provides the service to the mobile body (30) based on a result of the authentication. When the mobile body (30) moves, the mobile communication system provides, in a second communication device (20) at the movement destination, the service to the mobile body (30) based on the identification information from the mobile body (30) and the authentication result obtained by the first communication device without performing authentication in the second communication device (20).

### TECHNICAL FIELD

The present invention relates to a mobile communication system configured to provide a service to a mobile body.

### BACKGROUND ART

In mobile communication, mobile edge computing (MEC) has been advocated. In the MEC, an MEC server is arranged at a mobile communication base station, for example, a long term evolution (LTE) base station, or at an access point. Further, for example, the MEC server is arranged a short distance from a user terminal within a preset range. As a result, the MEC has big advantages in that, for example, communication delay, that is, latency, is reduced and backhaul bandwidth is reduced. Those advantages are evaluated highly, and various ways of using the MEC have been proposed (see, for example, Non-Patent Literature 1).

As an example of how the MEC can be used, in Non-Patent Literature 1, for example, there are presented several systems such as those described below. In one of those systems, a video stream taken by a camera is transcoded by the MEC server, and the transcoded video stream is transferred from the MEC server to a core network on a low frequency band. In another system, the core network includes a cache, and packets from a content source, for example the Internet, are temporarily cached in the core network. Further, the packets are transmitted from the core network to the MEC server of an LTE base station by backhaul transfer on a low frequency band. The MEC server stores the received packets in a local cache and transfers the packets to a terminal.

As another example of how the MEC can be used, there is an information communication system described in Patent Literature 1, for example. In the information communication system described in Patent Literature 1, a member terminal receives homepage data from a common server device and displays the homepage on a liquid crystal display (LCD). Next, a user of the member terminal selects a service selection icon corresponding to a desired information providing service from service selection icons included in the displayed homepage, and inputs a selection. The member terminal receives the selection input and requests the common server device to execute the selected information providing service. As a result, the user of the member terminal can receive the desired information providing service from the common server device.

### CITATION LIST

### Patent Literature

[PTL 1] JP 11-68823 A

### Non Patent Literature

[NPL 1] “Mobile Edge Computing,” Introductory Technical White Paper, September 2014, pp. 1-36

### SUMMARY OF INVENTION

### Technical Problem

However, in the services using an MEC server as described above, there is a problem in that the services may be interrupted due to the movement of a mobile body, which is a terminal, and service continuity is not secured.

For example, a case in which a service using an MEC server is provided at a base station (hereinafter referred to as “communication device”) is assumed. In this case, when the mobile body moves and handover is performed between the mobile body and the communication device, a situation in which service continuity is not secured may occur. For example, when a mobile body receiving a service from a certain communication device moves and handover is performed, the mobile body is required to receive the service from another communication device at the movement destination. At this time, the mobile body is required to perform an authentication procedure with respect to the another communication device at the movement destination. However, it takes time to perform the processing of the authentication procedure, and therefore provision of the service does not immediately start from the another communication device at the movement destination. As a result, provision of the service to the mobile body is temporarily halted. In this way, there is a problem in that when the mobile body moves, the continuity of providing the service from the communication device to the mobile body is not secured.

The present invention has been made to solve the problem described above, and an object of the present invention is to provide a mobile communication system capable of preventing a service from being interrupted.

### Solution to Problem

According to one embodiment of the present invention, there is provided a mobile communication system including: a first communication device configured to provide a service in response to a request from a mobile body; and a second communication device having a communication area different from a communication area of the first communication device and being configured to provide a service in response to a request from the mobile body, the mobile body including: an identification information transmission unit configured to transmit identification information on the mobile body to the first communication device; a first authentication permission notification information reception unit configured to receive authentication permission notification information for the identification information from the first communication device; and a service reception unit configured to receive the service from the first communication device when the first authentication permission notification information reception unit receives the authentication permission notification information, the first communication device including: an identification information reception unit configured to receive the identification information from the mobile body; an authentication permission notification information transmission unit configured to authenticate whether the identification information received by the identification information reception unit is proper, and to transmit the authentication permission notification information to the mobile body when it is determined that the identification information is proper; and a first service transmission unit configured to transmit the service to the mobile body when the identification information is determined to be proper by the authentication permission notification information transmission unit, the second communication device including: a second authentication permission notification information reception unit configured to receive from the mobile body the authentication permission notification information transmitted by the first communication device to the mobile body; and a second service transmission unit configured to transmit the service to the mobile body when the authentication permission notification information received by the second authentication permission notification information reception unit is proper.

### Advantageous Effects of Invention

The present invention can prevent the service from being interrupted.

### BRIEF DESCRIPTION OF DRAWINGS

FIG. 1 is a block diagram for illustrating an outline of a configuration of a mobile communication system including a communication device according to a first embodiment of the present invention.

FIG. 2 is a flowchart for illustrating operation of the communication device in the first embodiment of the present invention.

FIG. 3 is a diagram for illustrating a communicable area of the communication device in the first embodiment of the present invention.

FIG. 4 is a block diagram for illustrating an outline of a configuration of a mobile communication system including a communication device according to a second embodiment of the present invention.

FIG. 5 is a flowchart for illustrating operation of the communication device in the second embodiment of the present invention.

### DESCRIPTION OF EMBODIMENTS

### First Embodiment

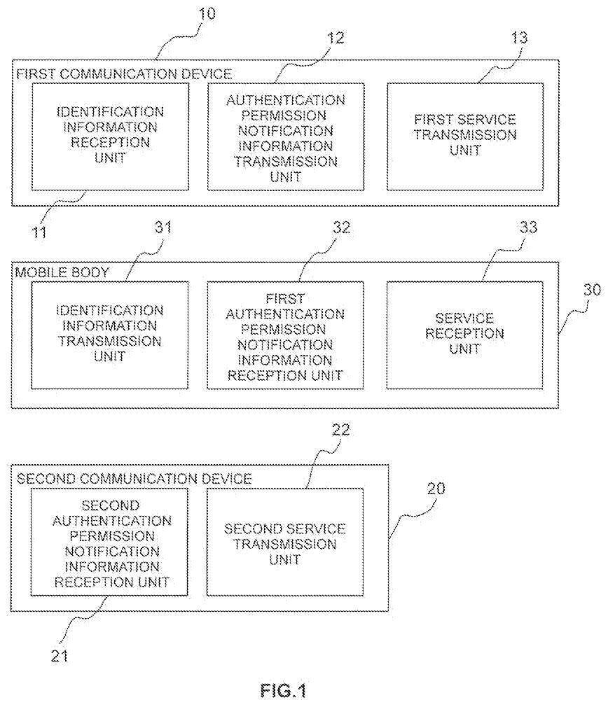

A mobile communication system according to a first embodiment of the present invention is now described with reference to FIG. 1 to FIG. 3. FIG. 1 is a diagram for illustrating a configuration of the mobile communication system according to the first embodiment.

As illustrated in FIG. 1, the mobile communication system according to the first embodiment includes a first communication device 10 and a second communication device 20. The first communication device 10 and the second communication device 20 each function as a base station of the mobile communication system. The first communication device 10 and the second communication device 20 are configured to provide various services in response to a request from a mobile body 30. The mobile body 30 is constructed of, for example, a mobile terminal.

In FIG. 1, only two communication devices, namely, the first communication device 10 and the second communication device 20, are illustrated, but in reality, a large number of two or more communication devices are provided. Those communication devices are arranged at intervals having a preset distance.

The first communication device 10, the mobile body 30, and the second communication device 20 are now described.

First, the first communication device 10 is described. As illustrated in FIG. 1, the first communication device 10 includes an identification information reception unit 11, an authentication permission notification information transmission unit 12, and a first service transmission unit 13. Each of those units is now described below.

The identification information reception unit 11 is configured to receive identification information transmitted from an identification information transmission unit 31, which is described later, of the mobile body 30. The identification information is unique ID information for identifying the mobile body 30.

The authentication permission notification information transmission unit 12 is configured to perform authentication of the identification information on the mobile body 30 received by the identification information reception unit 11. The authentication permission notification information transmission unit 12 transmits authentication permission notification information to the mobile body 30 when the mobile body 30 is successfully authenticated. In the mobile body 30, the authentication permission notification information is received as an authentication result by a first authentication permission notification information reception unit 32 described later. The authentication performed here is processing of determining whether or not the mobile body 30 is a properly registered mobile body by confirming whether or not a contract for the relevant service has been properly concluded for the mobile body 30.

The first service transmission unit 13 is configured to provide the service to the properly registered mobile body 30 based on the authentication result obtained by the authentication permission notification information transmission unit 12. The service may be, for example, a safety support service between vehicles, or a safety support service between vehicles and pedestrians. It should be understood, however, that the service is not limited to those services.

Next, the mobile body 30 is described. As illustrated in FIG. 1, the mobile body 30 includes the identification information transmission unit 31, the first authentication permission notification information reception unit 32, and a service reception unit 33. Each of those units is now described below.

The identification information transmission unit 31 is configured to transmit identification information on the mobile body 30 to the first communication device 10 or the second communication device 20 depending on the position of the mobile body 30. That is, when the mobile body 30 is present in a communicable area of the first communication device 10, the identification information transmission unit 31 transmits the identification information to the first communication device 10. The term “communicable area” refers to a communication area in which communication can be performed to and from the mobile body 30, and is an area preset for each communication device. When the mobile body 30 subsequently moves and enters the communicable area of the second communication device 20, the identification information transmission unit 31 transmits, to the second communication device 20, the identification information on the mobile body 30 and the authentication permission notification information notified from the first communication device. In this way, when starting communication, the identification information transmission unit 31 transmits only the identification information on the mobile body 30 to the communication device. When the communication device has been changed clue to the movement of the mobile body 30, the identification information transmission unit 31 transmits the authentication permission notification information notified from the communication device before the movement together with the identification information on the mobile body 30 to the communication device after the movement. A code for identifying the issuing communication device is added to the authentication permission notification information.

The first authentication permission notification information reception unit 32 is configured to receive the authentication permission notification information from the first communication device 10 or the second communication device 20, and to output the received authentication permission notification information to the identification information transmission unit 31.

The service reception unit 33 is configured to receive, when the first authentication permission notification information reception unit 32 receives the authentication permission notification information, the service provided by the first communication device 10 or the second communication device 20.

Next, the second communication device 20 is described. As illustrated in FIG. 1, the second communication device 20 includes a second authentication permission notification information reception unit 21 and a second service transmission unit 22. Each of those units is now described below.

The second authentication permission notification information reception unit 21 is configured to receive the identification information and the authentication permission notification information transmitted from the identification information transmission unit 31 of the mobile body 30. The second authentication permission notification information reception unit 21 determines whether or not the authentication permission notification information received from the identification information transmission unit 31 of the mobile body 30 is proper. The authentication permission notification information includes a code for identifying the issuing communication device, and therefore, as the determination method, determination regarding whether or not the authentication permission notification information is proper may be performed by checking the code.

The second service transmission unit 22 is configured to provide to the mobile body 30, when the authentication permission notification information is proper, a service equivalent to the service provided by the first service transmission unit 13 of the first communication device 10 without authenticating the mobile body 30.

In FIG. 1, for ease of understanding, the first communication device 10 and the second communication device 20 are illustrated as having different configurations from each other, but actually, the first communication device 10 and the second communication device 20 have the same configuration. That is, in reality, the first communication device 10 further includes a part that is the same as the second authentication permission notification information reception unit 21. Further, the second communication device 20 further includes a part that is the same as the identification information reception unit 11 and a part that is the same as the authentication permission notification information transmission unit 12.

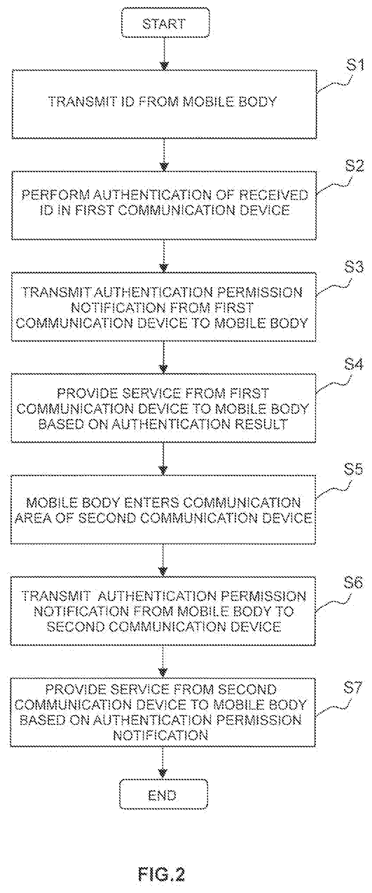

Next, operation of the mobile communication system according to the first embodiment is described with reference to the flowchart of FIG. 2.

In FIG. 2, in Step S1, the identification information transmission unit 31 of the mobile body 30 transmits the identification information on the mobile body 30 to the first communication device 10.

In Step S2, the first communication device 10 receives the identification information on the mobile body 30 by the identification information reception unit 11, and performs authentication of the identification information on the mobile body 30 by the authentication permission notification information transmission unit 12.

In Step S3, when it is determined based on the authentication result obtained by the authentication permission notification information transmission unit 12 that the identification information on the mobile body 30 is proper, the first communication device 10 transmits the authentication permission notification information from the authentication permission notification information transmission unit 12 to the mobile body 30.

In Step S4, the first communication device 10 provides the service from the first service transmission unit 13 to the mobile body 30 in accordance with the authentication result obtained by the authentication permission notification information transmission unit 12.

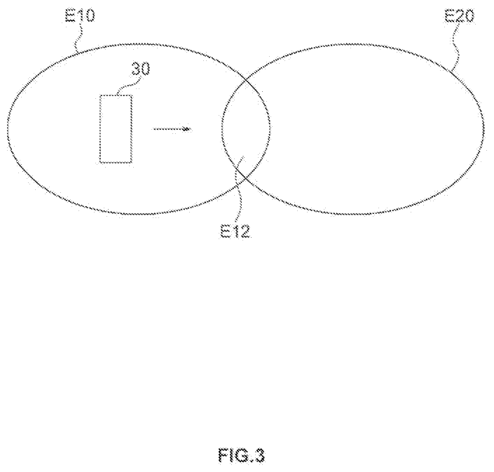

In Step S5, the mobile body 30 moves from the communicable area of the first communication device 10 toward the communicable area of the second communication device 20. The communicable area is now specifically described with reference to FIG. 3. As illustrated in FIG. 3, a communicable area E10 of the first communication device 10 and a communicable area E20 of the second communication device 20 are arranged adjacent to each other. A part of the communicable area E10 of the first communication device 10 and a part of the communicable area E20 of the second communication device 20 overlap each other at an area E12. Step S5 is a state in which the mobile body 30 has entered the communicable area E20 including the area E12.

In Step S6, the identification information transmission unit 31 of the mobile body 30 transmits the identification information and the authentication permission notification information to the second communication device 20. The authentication permission notification information is information transmitted by the authentication permission notification information transmission unit 12 of the first communication device 10 and received by the first authentication permission notification information reception unit 32 of the mobile body 30.

In Step S7, when the second authentication permission notification information reception unit 21 of the second communication device 20 receives the identification information and the authentication permission notification information from the mobile body 30, the second authentication permission notification information reception unit 21 confirms whether or not the received authentication permission notification information is proper. The second authentication permission notification information reception unit 21 recognizes, when it is determined that the authentication permission notification information is proper, the mobile body 30 as a mobile body to which the provision of the service is permitted. As a result, the second service transmission unit. 22 of the second communication device 20 starts providing the service to the mobile body 30.

The confirmation performed in Step S7 regarding whether or nos the authentication permission notification information is proper does not perform authentication of the mobile body 30, but only confirms that the issuing communication device is the first communication device 10 based on the code added to the authentication permission notification information. Therefore, the confirmation performed in Step S7 does not require time to perform the authentication procedure.

As described above, in the mobile communication system of the first embodiment, when the mobile body 30 moves from the communicable area E10 of the first communication device to the communicable area E20 of the second communication device 20, the mobile body 30 transmits authentication permission notification information received from the first communication device 10 together with identification information to the second communication device 20. As a result, at the second communication device 20, the service can immediately start to be provided only through confirmation of the authentication permission notification information without performing authentication processing of the mobile body 30. Therefore, according to the mobile communication system of the first embodiment, it is possible to prevent the service from being interrupted by the movement of the mobile body 30. As a result, service quality, for example, Quality of Experience (QoE), can be improved, and customer satisfaction can be enhanced.

### Second Embodiment

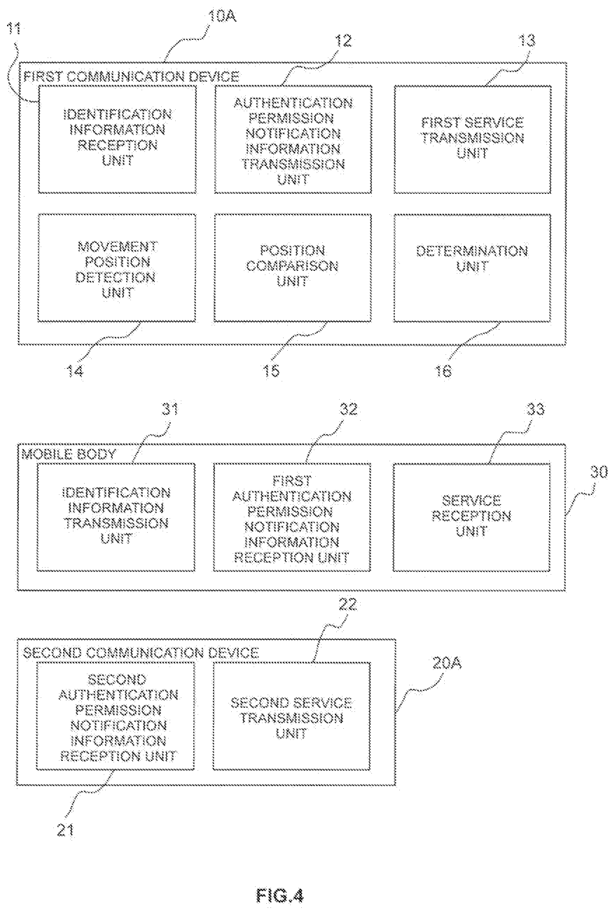

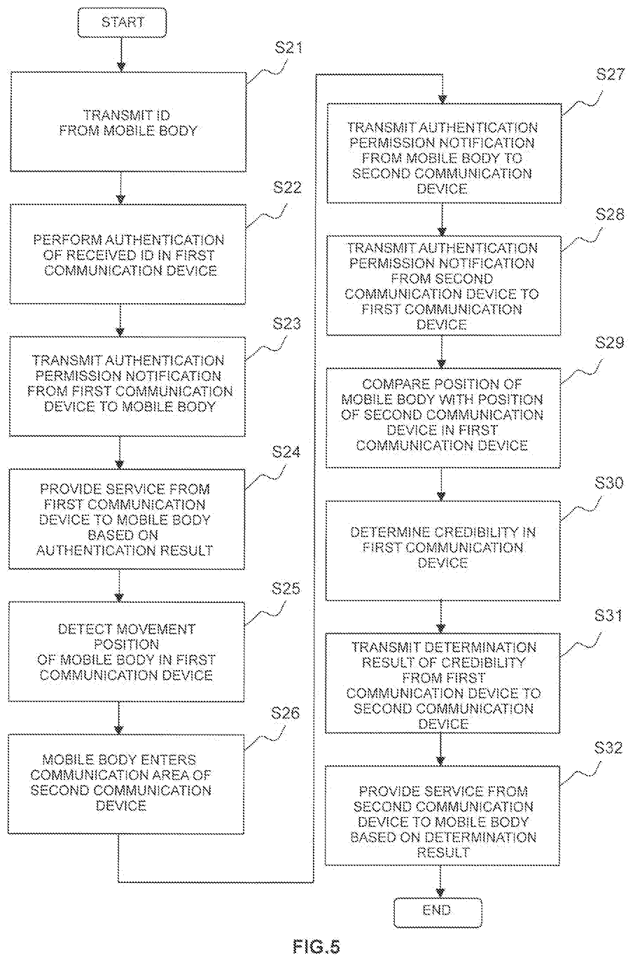

A mobile communication system according to a second embodiment of the present invention is now described with reference to FIG. 4 and FIG. 5. FIG. 4 is a diagram for illustrating a configuration of the mobile communication system according to the second embodiment. FIG. 5 is a flowchart for illustrating operation of the mobile communication system according to the second embodiment.

As illustrated in FIG. 4, the mobile communication system according to the second embodiment includes a second communication device 10A and a second communication device 20A. The first communication device 10A and the second communication device 20A each function as a base station of the mobile communication system. The first communication device 10A and the second communication device 20A are configured to provide various services in response to a request from the mobile body 30. The mobile body 30 is constructed of, for example, a mobile terminal.

In FIG. 4, only two communication devices, namely, the first communication device 10A and the second communication device 20A, are illustrated, but in reality, a large number of two or more communication devices are provided. Those communication devices are arranged at intervals having a preset distance.

The first communication device 10A additionally includes, compared with the configuration of the first communication device 10 of FIG. 1, a movement position detection unit 14, a position comparison unit 15, and a determination unit 16. That is, the first communication device 10A includes the identification information reception unit 11, the authentication permission notification information transmission unit 12, the first service transmission unit 13, the movement position detection unit 14, the position comparison unit 15, and the determination unit 16.

Operation of the identification information reception unit 11, the authentication permission notification information transmission unit 12, and the first service transmission unit 13 is the same as that in the first embodiment, and therefore description thereof is omitted here.

The movement position detection unit 14 is configured to detect the position of the mobile body 30.

The position comparison unit 15 is configured to compare the position of the mobile body 30 detected by the movement position detection unit 14 with the position of the second communication device 20A, and determine whether or not the mobile body 30 is present in the communicable area E20 of the second communication device 20A.

The determination unit 16 is configured to confirm, when the identification information on the mobile body 30 and the authentication permission notification information are received from the second authentication permission notification information reception unit 21 of the second communication device 20A, whether or not the current communication destination of the mobile body 30 is the second communication device 20A. When the current communication destination of the mobile body 30 is the second communication device 20A, the determination unit 16 determines that the authentication permission notification information has credibility. In the second embodiment, the determination unit 16 confirms whether or not the current communication destination of the mobile body 30 is the second communication device 20A based on a comparison result obtained by the position comparison unit 15, and determines the credibility of the authentication permission notification information on the mobile body 30 notified from the second communication device 20A. The method of confirming whether or not the current communication destination of the mobile body 30 is the second communication device 20A is not limited to the confirmation method based on the comparison result obtained by the position comparison unit 15, and another method may be used. For example, the current communication destination may be confirmed by requesting the mobile body 30 to transmit a code indicating the current communication destination.

Similarly to the second communication device 20 of FIG. 1, the second communication device 20A includes a second authentication permission notification information reception unit 21 and a second service transmission unit 22. Operation of the second authentication permission notification information reception unit 21 and the second service transmission unit 22 is different from that in the first embodiment.

The second authentication permission notification information reception unit 21 receives the identification information and the authentication permission notification information from the identification information transmission unit 31 of the mobile body 30. Further, the second authentication permission notification information reception unit 21 notifies the first communication device 10 of the received identification information and authentication permission notification information as well as position information on the second communication device 20A. The second authentication permission notification information reception unit 21 also receives the determination result from the determination unit 16 of the first communication device 10A.

The second service transmission unit 22 provides the service to the mobile body 30 when the authentication permission notification information transmitted by the mobile body 30 to the second communication device 20A is proper based on the determination result from the determination unit 16 of the first communication device 10A received by the second authentication permission notification information reception unit 21.

In FIG. 4, the first communication device 10A and the second communication device 20A are illustrated as having different configurations from each other, but actually, the configurations of those devices are the same.

The rest of the configuration of the second embodiment is the same as the configuration of the first embodiment described above, and therefore description thereof is omitted here. Further, parts that are the same as those in the first embodiment are denoted with the same reference numerals used in the first embodiment.

Next, operation of the mobile communication system according to the second embodiment is described with reference to the flowchart of FIG. 5.

In FIG. 5, Step S21 to Step S24 are the same as Step S1 to Step S4 of FIG. 2, and therefore description thereof is omitted here.

In Step S25, the movement position detection unit 14 of the first communication device 10A detects the position of the mobile body 30. The movement position detection unit 14 continues to detect the position during a time period in which the mobile body 30 is in the communicable area E10 of the first communication device 10A.

Step S26 and Step S27 are the same as Step S5 and Step S6 of FIG. 2, respectively, and therefore description thereof is omitted here.

In Step S26, when the second authentication permission notification information reception unit 21 of the second communication device 20A receives the identification information and the authentication permission notification information from the mobile body 30, the second authentication permission notification information reception unit 21 notifies the first communication device 10 of the received identification information and authentication permission notification information as well as the position information on the second communication device 20A. The second communication device 20A is fixed, and therefore it is assumed that the position information on the second communication device 20A is stored in a memory of the second communication device 20A in advance.

In Step S29, the position comparison unit 15 of the first communication device 10 compares the position information on the mobile body 30 detected by the movement position detection unit 14 with the position information on the second communication device 20 transmitted from the second communication device 20, and determines whether or not the mobile body 30 is present in the communicable area E20 of the second communication device 20A. The determination method is as follows, for example. It is assumed that the communicable area of each communication device is a circle having a radius “r” centered on the position of each communication device. In this case, when the distance between the position information on the mobile body 30 and the position information on the second communication device 20A is the radius “r” or less, it can be determined that the mobile body 30 is present in the communicable area E20. As another example, whether or not the mobile body 30 is present in the communicable area E20 of the second communication device 20A may be determined by comparing the position information on the mobile body 30 with the position information on the communicable area E20 of the second communication device 20A.

In Step S30, the determination unit 16 of the first communication device 10 determines the credibility of the authentication permission notification information from the mobile body 30 based on the determination result obtained by the position comparison unit 15. That is, the determination unit 16 determines that the mobile body 30 has proper authentication permission notification information when, based on the determination result obtained by the position comparison unit 15, the mobile terminal 30 is present in the communicable area E20 of the second communication device 20A.

The credibility determination by the determination unit 16 performed in Step S30 does not perform authentication of the mobile body 30, but only confirms the determination result of the position comparison unit 15, and therefore time is not required to perform the authentication procedure. Thus, processing time is not required.

In Step S31, the determination unit 16 of the first communication device 10A transmits the determination result to the second communication device 20.

In Step S32, the second communication device 20A recognizes, when the authentication permission notification information on the mobile body 30 is proper based on the determination result from the first communication device 10A, that provision of the service to the mobile body 30 may be permitted, and starts providing the service to the mobile body 30.

As described above, in the second embodiment, when the mobile body 30 moves from the communicable area E10 of the first communication device 10 to the communicable area E20 of the second communication device 20, the mobile body 30 transmits authentication permission notification information received from the first communication device 10A together with identification information to the second communication device 20A. Next, the authentication permission notification information is transmitted from the second communication device 20A to the first communication device 10A. In response to this, the first communication device 10A confirms whether or not the mobile body is present in the communicable area E20 of the second communication device 20A. When the mobile body 30 is present in the communicable area E20 of the second communication device 20A, the determination unit 16 of the first communication device 10 determines that the mobile body 30 has proper authentication permission notification information. As a result, the second communication device 20A starts providing the service to the mobile body 30 based on the determination result from the determination unit 16. The processing by the position comparison unit 15 and the determination unit 16 does not require time, and therefore the second communication device 20A can immediately start to provide the service to the mobile body 30. Therefore, in the second embodiment, it is possible to prevent the service from being interrupted by the movement of the mobile body 30. As a result, service quality, for example, QoE, can be improved, and customer satisfaction can be enhanced.

In the first and second embodiments, there are described examples in which the mobile body 30 enters the communicable area E20 of one of the second communication devices 20 and 20A from the communicable area E10 of one of the first communication devices 10 and 10A. It should be understood, however, that the operations are the same when the reverse is the case. That is, when the mobile body 30 enters the communicable area E10 of one of the first communication devices 10 and 10A from the communicable area E20 of one of the second communication devices 20 and 20A, in the description of the first and second embodiments, the term the “first communication device” may be read as “second communication device,” and the term “second communication device” may be read as “first communication device.”

The first and second embodiments are described above as examples. The various features, modes, and functions describes in the first and second embodiments are not limited to application to a certain embodiment, and may be applied individually or in various combinations to each embodiment.

Therefore, it is envisioned that an unlimited number of modification examples not exemplified here are within the scope of the technology disclosed in the present invention. For example, cases in which at least one constituent element is modified, added, or omitted are included in the scope of the technology disclosed in the present invention.

### INDUSTRIAL APPLICABILITY

As described above, the present invention is suitable for a communication device, a mobile communication system, and a mobile communication network system which are configured to provide a service to a mobile body.

### REFERENCE SIGNS LIST

10, 10A first communication device, 11 identification information reception unit, 12 authentication permission notification information transmission unit, 13 first service transmission unit, 14 movement position detection unit, 15 position comparison unit, 16 determination unit, 20, 20A second communication device, 21 second authentication permission notification information reception unit, 22 second service transmission unit, 30 mobile body, 31 identification information transmission unit, 32 first authentication permission notification information reception unit, 33 service reception unit

1. A mobile communication system, comprising:
a first communication device configured to provide a service in response to a request from a mobile body; and
a second communication device having a communication area different from a communication area of the first communication device and being configured to provide a service in response to a request from the mobile body,
the mobile body including:
an identification information transmission unit configured to transmit identification information on the mobile body to the first communication device;
a first authentication permission notification information reception unit configured to receive authentication permission notification information for the identification information from the first communication device; and
a service reception unit configured to receive the service from the first communication device when the first authentication permission notification information reception unit receives the authentication permission notification information,
the first communication device including:
an identification information reception unit configured to receive the identification information from the mobile body;
an authentication permission notification information transmission unit configured to authenticate whether the identification information received by the identification information reception unit is proper, and to transmit the authentication permission notification information to the mobile body when it is determined that the identification information is proper; and
a first service transmission unit configured to transmit the service to the mobile body when the identification information is determined to be proper by the authentication permission notification information transmission unit,
the second communication device including:
a second authentication permission notification information reception unit configured to receive from the mobile body the authentication permission notification information transmitted by the first communication device to the mobile body; and
a second service transmission unit configured to transmit the service to the mobile body when the authentication permission notification information received by the second authentication permission notification information reception unit is proper.

2. The mobile communication system according to claim 1,
wherein the second authentication permission notification information reception unit of the second communication device is configured to determine that the authentication permission notification information is proper when the authentication permission notification information received from the mobile body is issued by the first communication device, and
wherein the second service transmission unit of the second communication device is configured to transmit the service to the mobile body when the authentication permission notification information is proper based on a result of the determination by the second authentication permission notification information reception unit.

3. The mobile communication system according to claim 1,
wherein the second authentication permission notification information reception unit of the second communication device is configured to transmit the authentication permission notification information to the first communication device when the authentication permission notification information received from the mobile body,
wherein the first communication device further includes a determination unit configured to confirm whether a current communication destination of the mobile body is the second communication device when the authentication permission notification information is received from the second authentication permission notification information reception unit of the second communication device, and to determine, when the current communication destination of the mobile body is the second communication device, that the authentication permission notification information has credibility and determine that the authentication permission notification information is proper, and
wherein the second service transmission unit of the second communication device is configured to transmit the service from the second service transmission unit to the mobile body when the authentication permission notification information is proper based on a result of the determination from the determination unit of the first communication device.

4. The mobile communication systems according to claim 3,
wherein the first communication device further includes:
a movement position detection unit configured to detect a position of the mobile body; and
a position comparison unit configured to determine whether the mobile body is present in the communication area of the second communication device by comparing position information on the mobile body detected by the movement position detection unit with position information on the second communication device, and
wherein the determination unit is configured to determine, when it is determined by the position comparison unit that the mobile body is present in the communication area of the second communication device, that the authentication permission notification information has credibility and that the authentication permission notification information is proper.
